(19) United States
(12) Patent Application Publication
(10) Pub. No.: US 2007/0133690 A1
(43) Pub. Date: Jun. 14, 2007

(54) Adaptive complexity control for motion estimation during video encoding

(76) Inventors: Jun Xin, Quincy, MA (US); Changsung Kim, Cerritos, CA (US); Anthony Vetro, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/301,928

(22) Filed: Dec. 13, 2005

(51) Int. Cl. H04N 11/04; H04N 7/12

(52) U.S. Cl. 375/240.24; 375/240.26

(57) ABSTRACT

A adaptive complexity control algorithm is proposed to reduce the complexity of H.264 motion estimation. The main idea is to limit the complexity of motion estimation based on the expected RD coding gain loss. In order to efficiently reduce the complexity to desired level, ACC is designed to provide complexity scalability in motion estimation so as to provide flexible tradeoff between video quality and computational complexity. With the proposed algorithm, we demonstrate that complexity of motion estimation can be reduced by ¾ without significant RD performance degradation.

### FIELD OF THE INVENTION

This invention relates generally to video encoding, and more particularly to adaptive controlling a complexity of motion estimation during the video encoding.

### BACKGROUND OF THE INVENTION

The H.264/AVC video compression standard provides an increased compression efficiency compared to prior standards. H.264, also known as MPEG-4 Part 10, is a standard for a digital video codec. The H.264 standard and the MPEG-4 Part 10 standard, ISO/IEC 14496-10, are technically identical. The technology described by the standard is also known as advanced video coding (AVC).

H.264/AVC achieves encoding gains through a set of advanced encoding tools, including variable block size motion compensation, quarter-pel motion compensation, and long-term memory motion compensation. However, it is difficult to select a set of optimal encoding parameters, including motion vectors and prediction modes, such that an optimal compression efficiency is achieved.

In particular, long term memory motion compensated prediction (LTMCP) with variable block sizes is the major computational complexity bottleneck in the H.264/AVC encoder. Without loss of generality, scalable complexity is preferred for real time video encoding when limited computational resources are available.

In the prior art, various attempts have been made to reduce the complexity of mode decision and motion estimation for the H.264/AVC encoder. One method determines an initial search center based on a correlation between motion vectors of different block sizes, Z. Zhou, M.-T. Sun, Y.-F. Hsu, “Fast variable block-size motion estimation algorithm based on merge and slit procedures for H.264/MPEG-4 AVC,” Proceedings of the 2004 International Symposium on Circuits and Systems, Vol. 3, May 2004.

Other methods use fast motion estimation processes, such as efficient predictive zonal algorithms (EPZs), A. M. Tourapis, O. C. Au, M. L. Liou, “Highly efficient predictive zonal algorithms for fast block-matching motion estimation,” IEEE Transactions on Circuits and Systems for Video Technology, Vol. 12, Issue 10, October 2002; UMHexagonS, Jianfeng Xu, Zhibo Chen, Yun He, “Efficient fast ME predictions and early-termination strategy based on H.264 statistical characters,” Proceedings of the Joint Conference of the Fourth International Conference on Information, Communications and Signal Processing, 2003 and the Fourth Pacific Rim Conference on Multimedia. Vol. 1, December 2003; and SEA, M. Yang, H. Cui, K. Tang, “Efficient tree structured motion estimation using successive elimination,” IEE Proceedings-Vision, Image and Signal Processing, Vol. 151, Issue 5, October 2004. Those methods reduce the number of searching points during motion estimation.

Other methods use a recent-biased search, Chi-Wang Ting, Hong Lam, Lai-Man Po, “Fast block-matching motion estimation via recent-biased search for multiple reference frames,” International Conference on Image Processing, Vol. 4, October 2004, and forward motion trace, M-J. Chen, Y-Y. Chiang, H-J Li, M-C. Chi, “Efficient multi-frame motion estimation algorithms for MPEG-4 AVC/JVT/H.264,” Proceedings of the 2004 International Symposium on Circuits and Systems, Vol. 3, May 2004, to reduce the complexity of long term memory motion compensation.

A mode decision method, based on a coarse-to-fine approach, assumes a monotonic rate-distortion (RD) relation across block sizes, P. Yin, H. C. Tourapis, A. M. Tourapis, J. Boyce, “Fast mode decision and motion estimation for JVT/H.264,” IEEE International Conference on Image Processing, Vol. 3, September 2003. However, a further reduction in complexity is still very desired.

Several methods directly control the complexity of the video encoder. Zhong et al. disclose controlling the encoding complexity by using buffer monitoring during the encoding process, U.S. Patent Application Publication No. 2003/0123540. Song et al. adjust early termination thresholds for motion estimation and a DCT transform uses an average number of searching points, U.S. Patent Application Publication No. 2003/0156644. El-Maleh et al. select a predictive and non-predictive coding section based on a configurable threshold in order to balance complexity in memory and processing time, U.S. Patent Application Publication No. 2005/0105615.

Most methods for controlling the encoding complexity heuristically approximate the computational complexity of the encoding process, and adjust thresholds to achieve an objective, such as a decision of the encoding mode, or an early termination of processes, such as DCT or motion estimation.

The major complexity in the encoding process is due to motion estimation and mode decision. However, up to now, an accurate control of the complexity of those processes has not been available.

### SUMMARY OF THE INVENTION

One embodiment of the invention provides an adaptive complexity control framework to efficiently control a complexity of a video encoding process, with long term memory motion compensate prediction (LTMCP), and predictive coding mode decision.

An objective of the invention is to provide a complexity scalable encoder. One embodiment of the invention provides an adaptive complexity control framework that uses variable block sizes to reduce the encoding complexity to a desired level with a minimum decrease in rate-distortion performance.

A method for controlling the computational complexity of motion estimation in motion compensated hybrid motion compensated video encoding is disclosed. A computational complexity of motion estimation is defined as a weighted number of searching points. A complexity control process allocates complexity hierarchically for groups of pictures, frames, macroblocks, block partitions, and blocks, in a descending order.

### BRIEF DESCRIPTION OF THE DRAWINGS

FIG. 1 is a diagram of a video encoder according to an embodiment of the invention;

FIG. 2 is a diagram of hierarchical levels of a video for complexity budget allocation;

FIG. 3 is a diagram of the steps of complexity budget allocation according to an embodiment of the invention;

FIG. 4 is a flow chart of adaptive complexity control according to an embodiment of the invention; and

FIG. 5 is an example J-C curve according to an embodiment of the invention.

### DETAILED DESCRIPTION OF THE PREFERRED EMBODIMENT

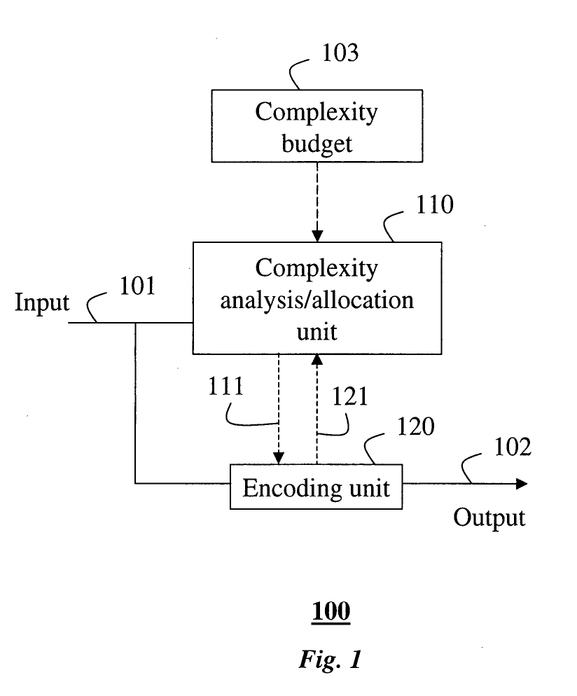

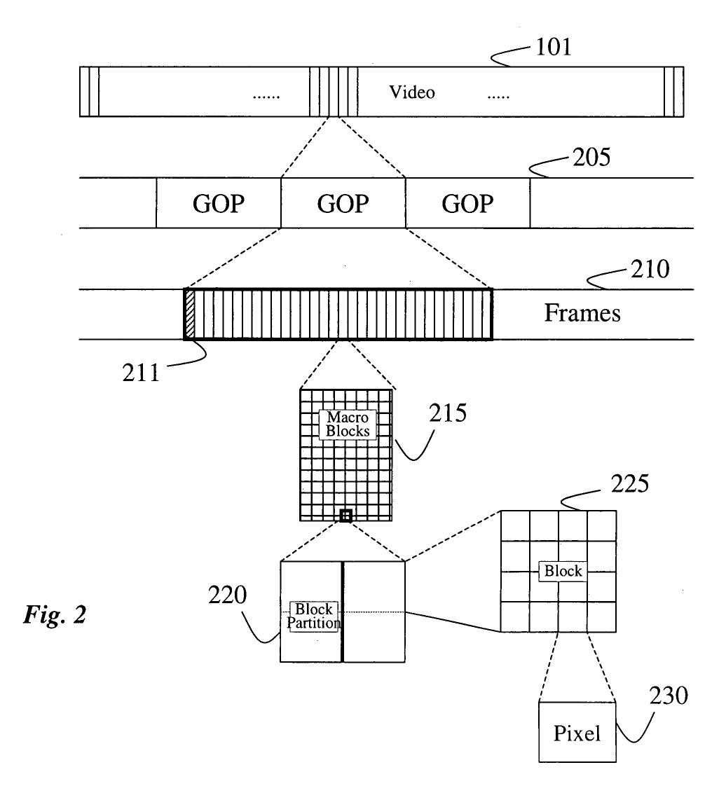

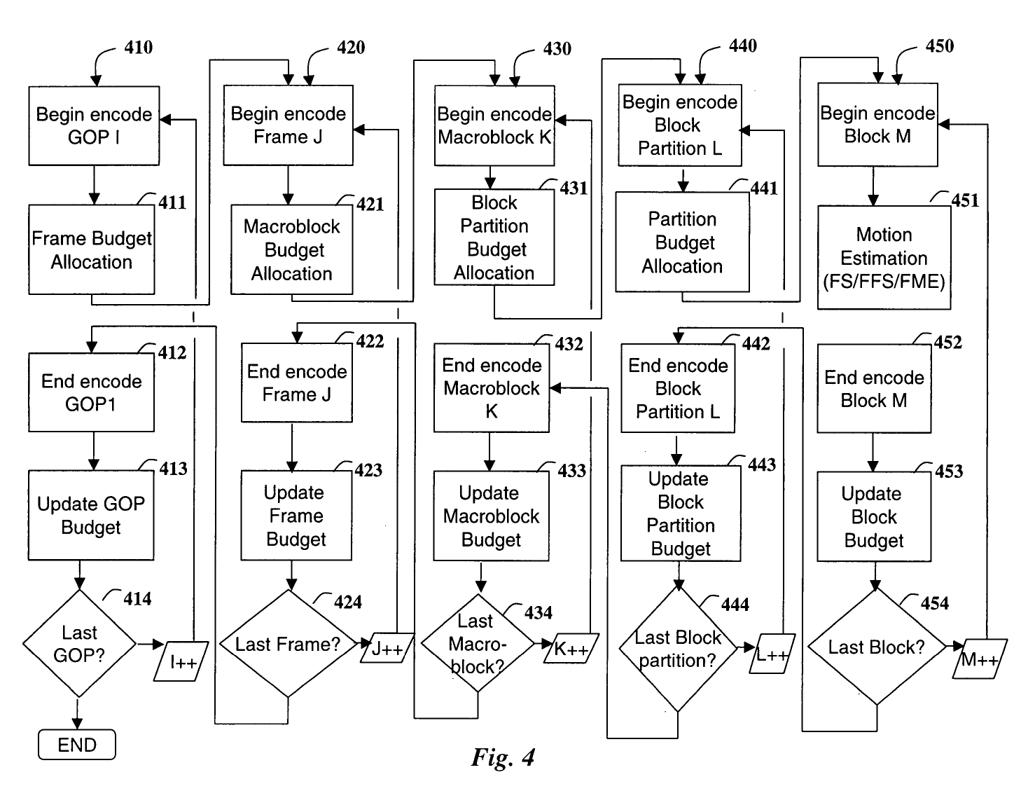

As shown in FIG. 1, one embodiment of the invention provides a system and method 100 for controlling a computational complexity of motion estimation while encoding 120 a video 101. The complete method is shown in FIG. 4. The complexity control method and system adaptively allocates a complexity budget 103 to hierarchical level of a video, as shown in FIG. 2.

In FIG. 1, the solid lines indicate data flow, and the dashed lines control. The system takes as input 101 a video, and produces as output 102 an encoded bitstream according to the complexity budget 103 provided by a particular application. The complexity budget 103 is allocated 110 to an encoding unit 120 according to an expected rate-distortion (RD) cost gains to achieve an optimal complexity allocation.

As shown in FIG. 2, the hierarchical levels can include the video 101, groups of pictures (GOP) 205, frames 210, macroblocks 215, block partitions 220, and blocks 225. Each block is a 4×4 array of pixels 230. The first frame 211 of a GOP is called an instantaneous decoding refresh picture (IDR).

Referring back to FIG. 1, the input video 101 is provided to the analysis and allocation unit 110 and the encoding unit 120. The encoding unit generates an output bitstream 102 subject to an apportioned complexity budget 111 for each hierarchical level. While encoding, the coding unit 120 outputs an actual consumed complexity budget 121 back to the complexity analysis/allocation unit 110. The allocation unit adjusts the apportioned complexity budgets 111 accordingly, in a dynamic manner.

The adaptive complexity control (ACC) method allocates available complexity budget 111 to the encoding unit 120 for each level such that the rate-distortion loss is minimized, subject to the given encoding time limit such as,

$${min}_{\overline{{C}_{x}}} {\sum }_{x = 1}^{N} Δ {J}_{x} = {J}_{x} - {J}_{OPT} = Δ {D}_{x} + λ \cdot Δ {R}_{x} subj . {\sum }_{x = 1}^{N} {t}_{x} \leq T \qquad ( 1 )$$

where N, c̅ₓ̅, J_{OPT}, tₓ and T represent a macroblock encoding instance, the vector of complexities allocated to the unit, Lagrangian RD cost when the given motion estimation algorithm is fully used without any complexity constraint, motion estimation time, and given encoding time budget for motion estimation, respectively.

The lambda (λ) is the Lagrangian multiplier, which controls the rate-distortion tradeoff during macroblock encoding, in our case, motion estimation, i.e., cost J=Distortion (D)+Lambda*Rate(R). For instance, when λ=0, the optimization minimizes the distortion, and when λ=∞, the optimization minimizes the rate. Generally, at a relatively low bit-rate, λ increases such that the rate term becomes a more significant part of the optimization.

The goal of the ACC method is to provide scalability in motion estimation complexity at each level of the encoding hierarchy. Therefore, the method enables the encoder to reduce complexity to a desired level for a particular motion estimation process. At the same time, the ACC method minimizes an expected RD performance degradation by employing a Lagrangian RD cost and motion estimation complexity, (J-C), curve based complexity allocation.

Definition of the Complexity of Motion Estimation

The computational complexity of motion estimation can be adjusted using a machine independent measure, proportional to the motion estimation time, such as a weighted number of searching points. In motion estimation, a block of an image is compared with a reference image to determine which block of the reference image best matches the block. To determine the best matching block in the reference image, a difference measure is used to measure an amount of difference between the macroblock and each possible block in the reference image.

A searching point is defined as a block in the reference image that is compared to the current block in the motion estimation process. The searching points are typically limited in a searching window. In exhaustive motion estimation, all possible searching points in the searching window are evaluated. A fast motion estimation method evaluates a subset of the all possible searching points in the searching window. The complexity in motion estimation is defined by a linear combination of a weighted number of searching points in each block partition as

$${\sum }_{k = 1}^{K} {\sum }_{l = 1}^{L} {\sum }_{m = 1}^{M} {ω}_{l} \cdot {C}_{m}^{k} ( i , j ) \leq {B}_{i} ( j ) , \qquad ( 2 )$$

where ωₗ represents a weight for a block partition with a block size l and Cₘ^{k} is the number of searching points for the partition m in the k^{th} macroblock. The variables K, L, M and Bᵢ(j) are the total number of macroblocks in a frame, number of block partitions for a given macroblock, the number of blocks in the block partition, and an assigned frame budget for the j^{-th} frame in the i^{-th} group of pictures (GOP), respectively. The weight ωₗ is based on the block partition because larger partitions consume more time to calculate the motion cost as,

$${ω}_{l} = \frac{Area ( q )}{Area ( {q}_{min} )} = \frac{N \times M}{{n}_{4 \times 4}} , \qquad ( 3 )$$

where N, M, and n_{4×4} are the horizontal block partition length in pixels, vertical block partition length in pixels, and the number of pixels in a minimum block. The number of pixels in a minimum block is, for example, sixteen. By replacing the constraint

$${\sum }_{x = 1}^{N} {t}_{x} \leq T$$

with Equation (2), Equation (1) becomes

$${min}_{\overline{{C}_{x}}} {\sum }_{x = 1}^{N} Δ {J}_{x} = {J}_{x} - {J}_{OPT} = Δ {D}_{x} + λ \cdot Δ {R}_{x} subj . {\sum }_{k = 1}^{K} {\sum }_{l = 1}^{L} {\sum }_{m = 1}^{M} {ω}_{l} \cdot {C}_{m}^{k} ( i , j ) \leq {B}_{i} ( j )$$

Complexity Control for Frame Level

Unconstrained motion estimation is performed on a first predictive frame. From the second predictive frame in the GOP, the frame level complexity budget Bᵢ(j), j=2, . . . , Nᵢ, is determined by subtracting the complexity budget bᵢ(j−1) that was allocated for motion estimation for the previous frame as described in Equation (4) from the previous target budget Bᵢ(j−1). For the remaining frames in the GOP, the complexity budget is increased when the processing time of unit complexity is decreased, and decreased otherwise.

The complexity budget for the current frame is allocated and updated for each frame successively as

$${B}_{i} ( j ) = \{ \begin{matrix}{R}_{i} ( j ) \cdot \frac{{N}_{i}}{Fr} + {B}_{i - 1} ( {N}_{i - 1} ) , j = 1 \\ {B}_{i} ( j - 1 ) - {b}_{i} ( j - 1 ) , j = 2 \\ {B}_{i} ( j - 1 ) - {b}_{i} ( j - 1 ) + ( {R}_{i} ( j - 1 ) - {R}_{i} ( j - 2 ) ) \\ \frac{{N}_{i} - j + 1}{Fr} , j = 3 , … , {N}_{i} ,\end{matrix} \qquad ( 4 )$$

where Bᵢ(j) is the complexity budget after the (j−1)^{th} frame in the i^{-th} GOP and

$${R}_{i} ( j ) = {\sum }_{k = 1}^{K} {\sum }_{l = 1}^{L} {\sum }_{m = 1}^{M} {ω}_{l} \cdot {C}_{m}^{k} ( i , j ) / {T}_{i} ( j ) , j = 1 ,$$

, is the normalized complexity at the motion estimation time Tᵢ(j) for the first predicted frame in the i^{-th} GOP. The variables Nᵢ, Fr, and bᵢ(j−1) are the total number of predicted frames, a predefined frame rate, and the actual complexity budget used in the (j−1)^{th} frame, respectively.

The initial normalized complexity, Rᵢ(j=1), is obtained by performing unconstrained motion estimation. The reason for a full motion search for the first frame is to obtain a ratio of weighted searching points and the motion estimation time. This prevents a decrease in RD performance due to inaccurate budget allocation for the first frame.

Complexity Control for Macroblock Level

The complexity budget \dot{B}ᵢ(j)=Bᵢ(j)/(Nᵢ−j+1), j=2, . . . , Nᵢ, for the current frame is initially allocated to each of the macroblocks M₁, . . . , M_{K} depending on an expected RD performance and associated required complexity. At the end of encoding each macroblock, the initial budgets for the remaining macroblocks are updated based on the complexity budget \dot{C}ⱼ^{MB} (k) and allocated to the previously encoded macroblocks. If the current frame is encoded with an initial budget plus a variable amount of additional budget \dot{B}ᵢ(j)±ΔB, then ∓AB is added to frame budget for remaining frames.

The complexity control for the macroblock levels is designed to allocate the available complexity budget to each macroblock so that the expected RD performance degradation is minimized by employing a J-C curve based allocation.

To estimate the J-C curve of the current macroblock, the curve of a collocated macroblock in a previous frame is stored in a memory at each iteration. The iteration can be defined as any number of weighted searching points. Here, it is defined as the number of weighted searching points used in one reference frame 1≦n_{ref}≦N_{ref} in each block size 1≦l≦L=7 such as Nₘₐₓ^{itr}=L×N_{ref}. If only one reference is used, then there can be seven iterations, i.e., (J, C) pairs, in the J-C curve maximally, where the block order is checked in descending order from 16×16 to 4×4.

From the experimental results indicated by the J-C curves, we observed that the majority of macroblocks with simple motion, such as background or smoothly moving objects, have linear J-C curves rather than a convex shape. On the other hand, macroblocks of complex motion indicated convex J-C curves, in general.

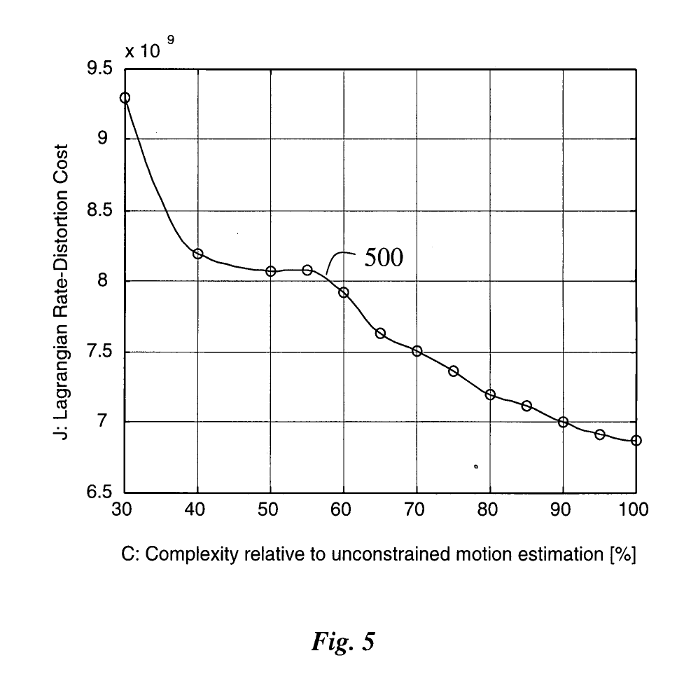

FIG. 5 shows an example J-C convex curve 500. The vertical axis J is the Lagrangian rate-distortion (RD) cost, and the horizontal axis C is the complexity relative to unconstrained motion estimation.

Intuitively, complex motion in detailed areas usually results in a large encoding cost for large blocks, and the cost converges to a lower level as the block size decreases. In contrast, areas with smooth motion quickly converge to a larger block size, in general. Also, we observed that there is a strong correlation between the J-C curves of the current macroblock and its temporally collocated macroblock. Therefore, the J-C curves of the current macroblock are estimated from the J-C curves of a collocated macroblock in the previous frame. The J-C slope mismatch problem from the estimation error is efficiently addressed through the partition-level budget adjustment and update.

The estimated J- C curve for each macroblock can have multiple slopes, which are maximally Nₘₐₓ^{itr}. To efficiently allocate the complexity budget to the frame, a greedy search is applied to the J-C curve to determine the complexity budget to allocate.

First, a minimum budget is allocated to each macroblock in the frame in order to prevent a block partition with a zero-value budget. A single point for each macroblock is selected as the minimum budget. Each point is assigned to a predicted motion vector for each macroblock. The predicted motion vector is the median vector of motion vectors in a spatial neighborhood of the macroblock. Based on the piecewise linear J-C curve, the initial budget is allocated for each macroblock using a greedy search until the budget is exhausted according to the following constraints.

Maximum Budget: If \dot{B}ᵢ(j)≧\dot{B}ᵢ(j−1), then the budget of each macroblock is determined by the maximum budget in the J-C curves of collocated macroblocks, and the remaining \dot{B}ᵢ(j)−\dot{B}ᵢ(j−1) is redistributed based on Equation (5) and the adjusted minimum complexity budget.

J-C Curve Approximation: Each macroblock in the previous frame can have nₖ≦Nₘₐₓ^{itr} iterations so it can have nₖ slopes according to

$${S}_{j - 1}^{MB = k} ( x ) = \vert \frac{Δ {\dot{J}}_{j - 1}^{MB = k} ( x )}{Δ {\dot{C}}_{j - 1}^{MB = k} ( x )} \vert = \vert \frac{{\dot{J}}_{j - 1}^{MB = k} ( x ) - {\dot{J}}_{j - 1}^{MB = k} ( x - 1 )}{{\dot{C}}_{j - 1}^{MB = k} ( x ) - {\dot{C}}_{j - 1}^{MB = k} ( x - 1 )} \vert ,$$

where k=[1, . . . , K], x=[1, . . . , nₖ] and k, x and K are the macroblock index, the iteration index, ad the total number of macroblocks in the frame, respectively. Each slope indicates a potential improvement in the RD coding gain at the iteration.

Convex hull of the J-C Curve: A convex hull is constructed for each macroblock by using a O(n log n) process as described by K. L. Clarkson and P. W. Shor, “Applications of Random Sampling in Computational Geometry, II,” Discrete and Computational Geometry, Vol. 4, No. 1, pp. 387-421, 1989, incorporated herein by reference.

Complexity Allocation: Because the estimated piecewise linear J-C curve is convex, a greedy search can be used to allocate searching points based on slope Sⱼ₋₁^{MB=k}(x).

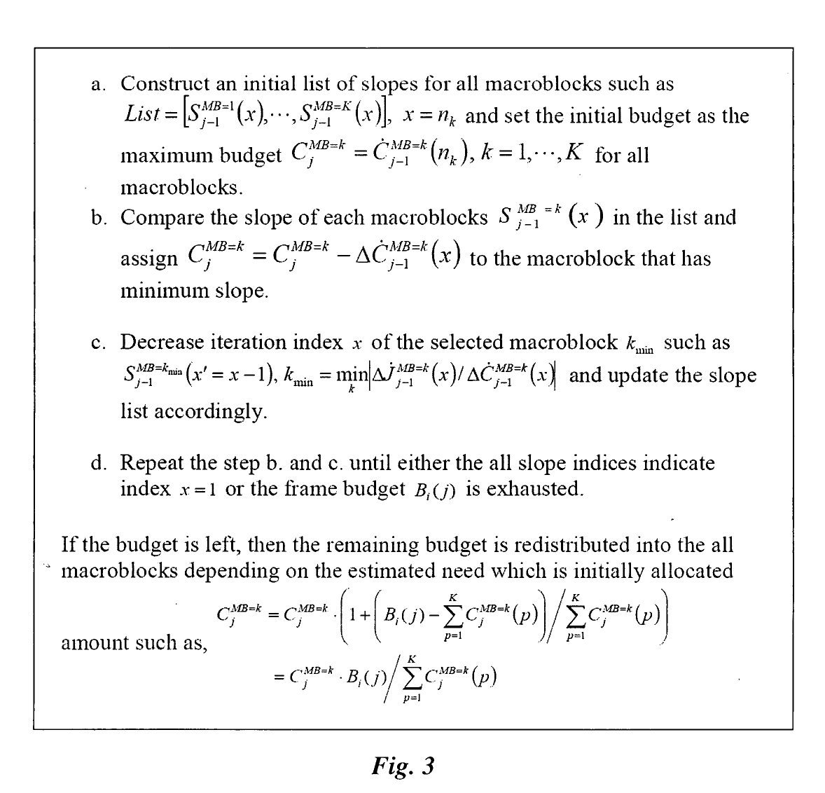

The remaining budget, which is the minimum budget subtracted from the total budget subtracted for each macroblock, is allocated as follows, as shown in FIG. 3:
a. Construct an initial list of slopes for all macroblocks such as List=[Sⱼ₋₁^{MB=1}(x), . . . , Sⱼ₋₁^{MB=K}(x)], x=nₖ and set the initial budget as the maximum budget Cⱼ^{MB=k}=\dot{C}ⱼ₋₁^{MB=k}(nₖ), k=1, . . . , K for all macroblocks.
b. Compare the slope of each macroblocks Sⱼ₋₁^{MB=k}(x) in the list and assign Cⱼ^{MB=k}=Cⱼ^{MB=k}−Δ\dot{C}ⱼ₋₁^{MB=k}(X) to the macroblock that has minimum slope.
c. Decrease iteration index x of the selected macroblock kₘᵢₙ such as

$${S}_{j - 1}^{MB = {k}_{min}} ( {x}^{′} = x - 1 ) , {k}_{min} = {min}_{k} \vert Δ {\dot{J}}_{j - 1}^{MB = k} ( x ) / Δ {\dot{C}}_{j - 1}^{MB = k} ( x ) \vert$$

and update the slope list accordingly.
d. Repeat the steps b. and c. until either the all slope indices indicate index x=1 or the frame budget Bᵢ(j) is exhausted.
e. If the budget is left, then the remaining budget is redistributed into the all macroblocks depending on the estimated need which is initially allocated amount such as,

$$\begin{matrix}{C}_{j}^{MB = k} = {C}_{j}^{MB = k} \cdot ( 1 + ( {B}_{i} ( j ) - {\sum }_{p = 1}^{K} {C}_{j}^{MB = k} ( p ) ) / {\sum }_{p = 1}^{K} {C}_{j}^{MB = k} ( p ) ) \\ = {C}_{j}^{MB = k} \cdot {B}_{i} ( j ) / {\sum }_{p = 1}^{K} {C}_{j}^{MB = k} ( p )\end{matrix} \qquad ( 5 )$$
f. In case of single slope approximation, a simple slope-weighted allocation using Equation (6) can be applied for initial allocation:

$${C}_{j}^{MB = k} = \frac{{\dot{B}}_{i} ( j ) \cdot {S}_{j - 1}^{MB = k}}{{\sum }_{k = 1}^{K} {S}_{j - 1}^{MB = k}} . \qquad ( 6 )$$

Next, the minimum complexity budgets are adjusted as follows. We perform motion estimation for each macroblock according to the initially assigned minimum complexity budget, where the J-C slope \tilde{S}ⱼ^{MB=k}(X) is measured at each iteration in the current frame. Even though temporally adjacent J-C curves are correlated, it is important to note that the J-C curve of the current macroblock can have different slopes with the collocated macroblock that was used for the initial allocation. Also, the J-C slope \tilde{S}ⱼ^{MB=k}(X) of the current macroblock is available when motion estimation is completed for a current iteration. In order to dynamically compensate the impact of J-C curve mismatch, a small number of searching points up to ε for additional iterations are conditionally allowed:
\dot{C}ⱼ^{MB=k}=Cⱼ^{MB=k}±ΔCⱼ^{MB=k}.

The amount of extra searching points ∓ΔCⱼ^{MB=k} is added to the macroblock budget for the remaining macroblocks. Intuitively, extra searching points ΔCⱼ^{MB=k} is a sum of increment or decrement under macroblock levels which can be assigned at block size level as long as the new slope is greater than the previous slope Sⱼ^{MB=k}(x+1)≧Sⱼ^{MB=k}(X), x≧nₖ until the pre-defined threshold |ΔCⱼ^{MB=k}|<ε is met.

After the motion estimation of current macroblock is completed, the complexity budget is updated. If all the macroblocks are encoded with the initial frame budget plus a variable amount of additional budget Bᵢ(j)±ΔB, then ∓ΔB is added to the frame budget for remaining frames.

Complexity Control for Block Partition Level

The complexity budget is allocated to the macroblocks as follows. For the k^{th} macroblock, the macroblock level complexity budget at frame j, Cⱼ^{MB=k} is allocated from the most probable block partition to the least probable one. The block partition is sorted according to a priority that is based on the estimated RD cost.

A fast inter mode decision process can be used for sorting the block partition, Qionghai Dai, Dongdong Zhu, Rong Ding, “Fast mode decision for inter prediction in H.264,” International Conference on Image Processing, Vol. 1, pp. 119-122, October 2004, incorporated herein by reference.

At the end of encoding each block partition, the initial budget for the remaining block partitions Cₖ^{BP=l′}, l<l′≦L are updated based on the complexity budget Cₖ^{BP=l} allocated to previously encoded block partitions. If all block partitions are encoded with the initial macroblock budget plus a variable amount of additional budget Cⱼ^{MB=k}±ΔCⱼ^{MB=k}, then ∓ΔCⱼ^{MB=k} is added to the macroblock budget for the remaining macroblocks. One embodiment of the invention, the encoder can allocate the macroblock budget to each block partition uniformly.

Complexity Control for Block Level

FIG. 4 shows the complexity control for the block level at the l^{th} block partition. The complexity budget for the block partition level of the macroblock k, Cₖ^{BP=l}, is allocated from the most probable block to the least probable one. The blocks are sorted according to a priority based on the estimated RD cost. The motion search is performed across multiple reference frames as long as the allocated block level budget Cₗ^{BL=m} is allowed.

At the end of encoding each block, the initial budgets for the remaining blocks Cₗ^{BL=m′}, m<m≦M are updated based on the complexity budget Cₗ^{BL=m} allocated to previously encoded blocks. If all the blocks are encoded with the initial block budget plus a variable amount of additional budget Cₖ^{BL=m}±ΔCₖ^{BL=m} then ∓ΔCₖ^{BL=m} is added to the block partition budget for the remaining block partitions. For simplicity, the encoder can allocate the block partition budget to each block uniformly.

FIG. 4 shows the iterations of the method for controlling a computational complexity of motion estimation while encoding a video in greater detail for each of the hierarchical levels. For each GOP 410, frame 420, macroblock 430, block partition 440, and block 450 perform the steps of allocating the frame 411, macroblock 421, block partition 431, block 441, and motion estimation 451, respectively. Then, at the end of the GOP 412, frame 422, macroblock 432, block partition 442, and block 452, update the GOP 413, frame 423, macroblock 433, block partition 443, and block 453 budgets, respectively until the last GOP 414, frame 424, macroblock 434, block partition 444, and block 454, respectively.

The block partition or set of block partitions for a given macroblock can be decided based on a given complexity budget for a macroblock.

It is to be understood that various other adaptations and modifications may be made within the spirit and scope of the invention. Therefore, it is the object of the appended claims to cover all such variations and modifications as come within the true spirit and scope of the invention.

We claim:

1. A method for encoding a video, comprising:
analyzing, in a top-to-bottom order, hierarchical levels of a video including a sequence of frames, each frame including a plurality of macroblocks;
allocating, in the top-to-down order, a portion of a complexity budget to each hierarchical level according to the analyzing; and
encoding each macroblock of the video according to the portion of the complexity budget allocated to the macroblock to produce an encoded bitstream.

2. The method of claim 1, in which the hierarchical levels include a video level, a group of pictures level, a frame level, a macroblock level, a block partition level, and a block level.

3. The method of claim 2 in which each block is a 4×4 array of pixels.

4. The method of claim 2, in which a first frame of a group of pictures is an instantaneous decoding refresh picture.

5. The method of claim 1, in which the encoding minimizes a rate-distortion loss subject to an encoding time limit.

6. The method of claim 5, in which the encoding time limit is
$${min}_{\overline{{c}_{x}}} {\sum }_{x = 1}^{N} Δ {J}_{x} = {J}_{x} - {J}_{OPT} = Δ {D}_{x} + λ \cdot Δ {R}_{x}$$
$$subj . {\sum }_{k = 1}^{K} {\sum }_{l = 1}^{L} {\sum }_{m = 1}^{M} {ω}_{l} \cdot {C}_{m}^{k} ( i , j ) \leq {B}_{i} ( j )$$
where N is a macroblock encoding instance, c̅ₓ̅ is a vector of complexities, J_{OPT} is a Lagrangian rate-distortion cost when motion estimation is applied without a complexity constraint, λ is a Lagrangian multiplier, ωₗ is a weight for a block partition having a block size l, Cₘ^{k} is a number of searching points for the partition m in a k^{th} macroblock, K is a total number of macroblocks in a frame, L is a number of block partitions for a given macroblock, M is a number of blocks in the block partition and Bᵢ(i) is an assigned frame budget for the j^{-th} frame in an i^{-th} group of pictures.

7. The method of claim 4, further comprising:
determining, for a group of pictures in the group of pictures level, unconstrained motion estimation of a first frame;
determining, for a next frame in the group of pictures level, a frame level complexity budget by subtracting a complexity budget allocated for motion estimation for the first frame from a target budget;
updating the complexity budget for remaining frames in the group of pictures by increasing the complexity budget if a processing time of frame level complexity is decreased; and otherwise
decreasing the complexity budget for remaining frames in the group of pictures.

8. A system for encoding a video, comprising:
a complexity analysis and allocation unit configured to analyze, in a top-to-bottom order, hierarchical levels of a video including a sequence of frames, each frame including a plurality of macroblocks, and to allocate, in the top-to-down order, a portion of a complexity budget to each hierarchical level according to the analyzing; and
an encoding unit configured to encode each macroblock of the video according to the portion of the complexity budget allocated to the macroblock to produce an encoded bitstream.
